(19) United States
(12) Patent Application Publication
(10) Pub. No.: US 2021/0182519 A1
(43) Pub. Date: Jun. 17, 2021

(54) CODE READER DEVICE AND METHOD FOR ONLINE VERIFICATION OF A CODE

(71) Applicant: CRETEC GMBH, Hammersbach (DE)

(72) Inventors: Alexander TREBING, Hammersbach (DE); Andreas WELZL, Weiden i. d. Oberpfalz (DE); Rainer GÜNTNER, Hammersbach (DE)

(73) Assignee: CRETEC GMBH, Hammersbach (DE)

(21) Appl. No.: 16/767,232

(22) PCT Filed: Nov. 26, 2018
(86) PCT No.: PCT/EP2018/082476

§ 371 Date: May 27, 2020

(30) Foreign Application Priority Data
Nov. 27, 2017 (DE) 10 2017 128 032.4

(51) Int. Cl. G06K 7/14; G06K 19/06

(52) U.S. Cl. CPC G06K 7/1443; G06K 19/06131

(57) ABSTRACT

A code reader device (10) as well as a method for online verification of a code (20), which is detected by an image sensor (14) of the code reader device (10) in an image, wherein the encoded information of the code (20) is read out and the code quality is judged according to predefined criteria. In order to allow an automatic online verification of different codes at different reading distances without having to recalibrate each time, it is proposed that codes (20) of different sizes and at different distances from the image sensor (14) are brought into focus automatically, a distance value of the code (20) or the object relative to the image sensor (14) is provided, norm-specific and distance-specific calibration parameters are provided on the basis of said distance value, and the read-in code (20) is verified automatically on the basis of said norm-specific and distance-specific calibration parameters and a predefined norm.

The invention relates to a code reader device according to the preamble of claim 1 as well as a method for automatic verification of a code according to the preamble of claim 10. Moreover, the invention relates to a modular code reading apparatus.

A code reader device and a method for online verification of a code is known from EP 2 677 492 A1.

A camera-based code reader takes pictures of the objects with the code located on them by means of a pixel-resolving image sensor, instead of scanning code regions. An image evaluation software then extracts the code information from these pictures. Camera-based code readers can also easily handle types of code other than one-dimensional bar codes, which are constructed in two dimensions such as a matrix code and which provide more information.

In order to assure high reading rates, the quality control of codes is also important. The judging of the code quality is also known as code verification. In this process, certain code properties are checked, such as are required for a reading of the code. This process may involve a decoding, the outcome of which may also be known in advance, and it then only needs to be confirmed. Standards have been agreed upon for code quality, such as those in ISO16022, ISO15415, ISO15416 or ISO29158.

In EP 2 677 492 A1 it is stated that a code verification traditionally takes place in an offline mode, in which certain physical boundary conditions are dictated. The code verification should assess the test object in a reproducible and reliable manner, rather than artifacts of the camera setup such as angle of detection, selected image magnification, or light exposure time. Instructions are given for this regarding the reading situation during the verification.

For example, a code verification is recommended at the center of the image, in order to avoid the margin region of the lens, and for this a target marking is specified, where the test object should be placed.

The boundary conditions to be satisfied furthermore include a known standard illumination without interference light from one or more known light sources, multiple and periodically recurring calibration cycles, an unchanging reading distance between test object and lens, and generally the dictating of a defined detection position both as regards the position of the code reader and that of the code being checked.

Such boundary conditions cannot be met in practice under actual conditions of online use.

The handling of such verification systems requires high skill on the part of the operator. In EP 2 677 492 A1, to simplify the code verification, a code reader is proposed having an image sensor for generating of images of a detection zone resolved in pixels, a decoding unit for identifying code regions in the images and reading of their encoded information, and a verification unit for judging the code quality according to predefined criteria.

The verification unit here is designed to generate at first a normalized verification image of the code from the code regions by means of an image processing for the verification.

The teaching disclosed in EP 2 677 492 A1 starts from the notion of circumventing the usual techniques for code verification. Instead of ensuring fixed, standardized physical boundary conditions, the circumstances on site are utilized. The standardized conditions are then produced afterwards by image processing. This produces a normalized verification image, which is used to judge the code quality.

But in this method a calibrating must be done before every changing of the code, the object, or the reading distance, which in turn requires high skill on the part of the operator.

Starting from this, the problem which the present invention proposes to solve is to modify a code reader device and a method for automatic verification of a code of the aforementioned kind so that both the calibrating and the verification are simplified.

The problem is solved according to the invention by a code reader device having the features of claim 1 and by a method for online verification of a code having the features of claim 10.

Further details, benefits and features of the invention will emerge not only from the claims and the features found therein, both alone and in combination, but also from the following description of a preferred exemplary embodiment shown in the drawing.

There are shown:

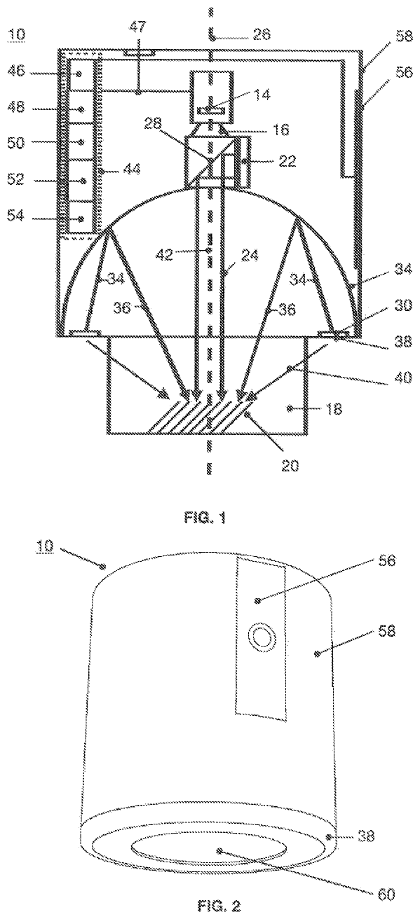

FIG. 1 a schematic sectional representation of a camera-based code reader device,

FIG. 2 a perspective representation of the code reader device,

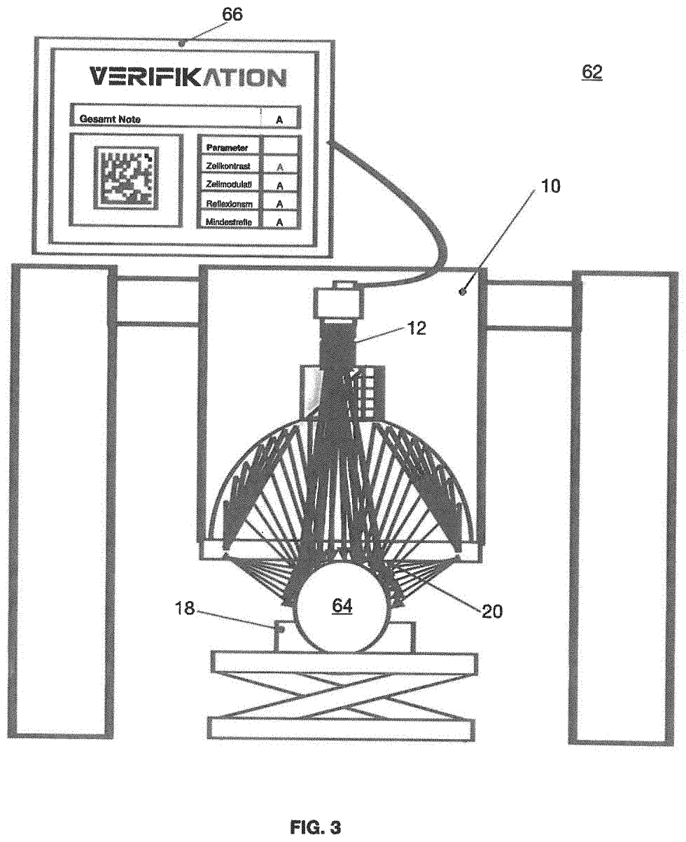

FIG. 3 a schematic representation of a device for automatic verification of a code,

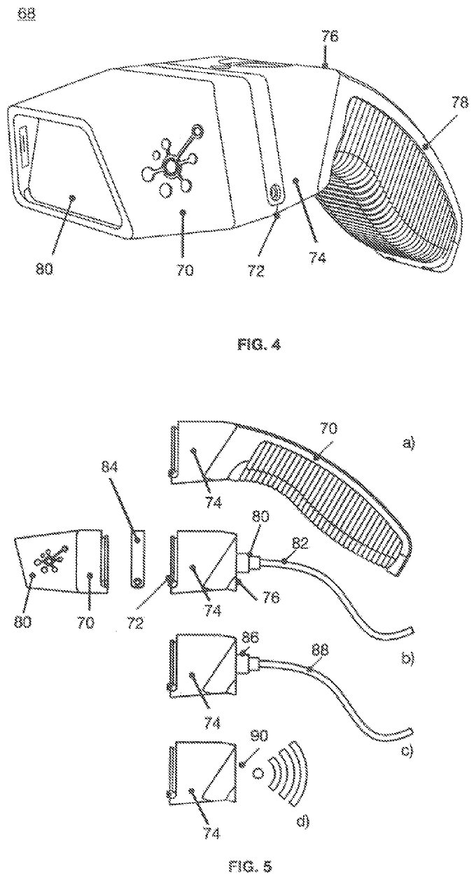

FIG. 4 a perspective representation of a scanning device, especially a hand scanner

FIG. 5 a)-d) modules of the hand scanner of FIG. 4

FIG. 1 shows a schematic sectional representation of a camera-based code reader 10. The code reader 10 comprises a camera 12 with integrated image sensor 14 having an upstream auto focus device 16. The camera 12 takes pictures of a detection zone 18 in which a desired object is located, having a code 20, which may have different sizes and different reading distances from the camera 12.

The code reader 10 furthermore comprises multiple illumination devices, a first illumination device being a coaxial illumination 22, providing a diffuse bright field 24 running parallel to an optical axis 26. The optical axis 26 passes through the image sensor 14 at right angles and likewise stands at right angles to the code 20. The coaxial illumination 22 emits light onto a translucent mirror 28, which reflects the diffuse bright field 24 in the direction of the inspection zone 18 or the code 20.

Furthermore, there is provided a second, preferably ring-shaped illumination 30 in the form of a dome illumination, which emits a diffuse stray field 32 toward a dome-shaped reflector 34, from which a diffuse stray field is reflected onto the code 20 with light beams oriented not parallel to the optical axis 26.

Moreover, a third illumination device is provided in the form of a dark field illumination 38, which his designed as a ring-shaped illumination at an end-face margin of the code reader 10 and which emits light beams 40 at a small angle a of around 30° onto the code 20.

The light beams 42 reflected from the inspection zone 18 are received by the auto focus unit 16 and brought into focus on the image sensor 14. The image sensor, such as a CCD or CMOS chip with a plurality of pixel elements arranged in a row or a matrix, generates image data of the inspection zone 18 and relays this to an evaluation unit 44. The evaluation unit 44 in the exemplary embodiment shown is integrated in the code reader 10, but it may also be connected externally across an interface 47. The evaluation unit 44 comprises a calibrating unit 46, a decoding unit 48, a verification unit 50, a camera controller 52 and an illumination controller 54.

For the display of measurement results and for operator control of the code reader 10, the evaluation unit 44 is coupled to a display and control unit 56, which is integrated in a housing 58 of the code reader 10 or which can be connected externally across the interface 47.

The calibrating unit 46 serves for an automatic normalized calibrating of the code reader in dependence on the type of code, the placement of the code on the object, and the focusing, i.e., the distance of the code 20 from the sensor 14.

For this, it is provided that norm-specific and distance-specific calibrating data are stored in the calibrating unit for each focus position of the auto focus unit 16. The calibrating data encompass settings for the illuminations 22, 30, 38 such as the illumination type, the illumination brightness and/or the illumination angle, as well as settings for the camera 14, such as aperture and/or light exposure time, which are provided to the camera controller 52 and/or the illumination controller 53 for adjusting a normalized illumination or normalized conditions.

The decoding unit 48 is adapted to decoding the code 20, i.e., to reading out the information contained in the code 20.

The verification unit 50 is able to evaluate the incoming image from an incoming image by various processing steps and to show the parameters of the verification on the display 56, such as the cell contrast, the cell modulation, the reflection marg. and minimum reflection.

The camera controller 52 is adapted to set the light exposure time and the aperture of the camera 14 according to the calibrating data provided by the calibrating unit 46.

The illumination controller is adapted to set the normalized illumination according to the calibrating data provided by the calibrating unit 46.

FIG. 2 shows in perspective representation one possible configuration of the code reader 10, having a cylindrical housing 58, the display and control unit 56 being integrated in the wall of the housing 58. The cylindrical housing has a light exit opening 60 at its end face, which is surrounded by the ring-shaped illumination unit 38. The camera 14, the optics and auto focus unit 16, and the illuminations 22, 30 are arranged in the interior of the housing 58.

The code reader 10 represented in FIG. 2 can alternatively be configured as a desktop device, a handheld device, or be integrated in a process metering device 62, as is represented in FIG. 3.

With respect to FIG. 3, the function of the code reader 10 shall be explained for the fully automatic online verification of codes 20 of different sizes and at different distances from the camera 12.

An object 64 with the code 20 being checked is placed automatically or manually by an attendant in the inspection zone 18 of the code reader 10. A standard for the verification of the code 20 is selected on the external display and control unit 56 or via a digital input. After this, the following steps are performed fully automatically:
initial image recording
checking of the focus
further image recording until the focus has been set properly (auto focus)
selection of norm-specific and distance-specific calibrating data on the basis of a distance value of the correct focus from a memory
checking of the illumination settings with the aid of standard benchmarks obtained from the calibrating data
further image recording until the illumination of the object 60 or the code 20 conforms to the standard criteria
evaluations of the image recorded under the standard criteria by means of the verification unit
displaying of verification parameters such as cell constant, cell modulation, reflection mag. and minimum reflection by the display and control unit
saving of the values, preferably in an internal memory or on a USB storage medium
printing out of a protocol

Unlike the prior art, the code reader 10 works entirely independently and needs no further calculating unit such as a personal computer. Only a power supply such as 24 VDC or 230 VAC [is needed].

The quality of the code 20 is marked clearly in color, for example by a red, yellow and green display. In this way, the verification of the code 20 is greatly simplified and can also be performed by untrained personnel.

The evaluation unit may have multiple digital outputs, in order to make possible an “inline” operation in addition to the “online” operation. The outputs are designed to be individually programmable.

According to the invention, the auto focus unit 16 which is integrated in the code reader 10 focuses the image field on the code 20, so that verifications can be performed fully automatically with variable distances from the code reader 10. Moreover, there is an automatic calibrating, so that a repeat calibrating is not needed when the code is changed or the distance (the reading distance) is changed.

Another significant feature of the invention worth mentioning is that the code reader 10 can be expanded with external illumination subassemblies, for example, in order to verify with the “low angle” illumination as defined in the standard.

For this, the illumination 38 is connected for example to the cylindrical margin of the housing 58. The illumination may be mounted externally on the margin, for example, and connected by a plug connector to the evaluation unit. The illumination can then be selected appropriately via the software running in the illumination controller 54. The code reader 10 then verifies the code 20 with the external illumination 38. The illumination used and further inspection parameters and illumination settings are noted appropriately in an inspection protocol.

FIG. 4 shows in perspective representation a modular design of a handheld scanner 68, comprising a main module 70, which can be connected across a first electromechanical interface 72 to an intermediate module 74. The intermediate module 74 can be connected across a second electromechanical interface 76 to a handle module 78.

The handheld scanner 68 is designed as an adaptive system, especially for image processing applications (intelligent camera) or industrial ID applications (1D/2D code reading).

Integrated in the main module 70 are an illumination unit, an image unit, an evaluation electronics, and preferably a target marking. Integrated in the intermediate module are a communication unit and optionally a power supply.

Adaptively, expansion units can be adapted to a further interface 80 of the main module 70, such as a diffuser/polar filter unit, a fiberoptic cable for low angle and/or dark field illumination, and various optics. The main module 70 can be adapted at the front end, where an optics unit can be exchanged in purely mechanical manner in order to achieve other image fields and/or focal points. Moreover, there is the option of expanding the internal illumination unit by means of optics in order to generate different light properties, such as direct incident light, diffuse incident light, low angle and/or dark field light.

The intermediate module 74 can be connected at the back side by means of the electromechanical interface 76 to the handle module 78, in order to form a handheld device. Alternatively, the option exists of designing the intermediate module 74 with the main module 70 as an independent unit (fix-mount system).

The system becomes functional by means of the communication unit integrated in the intermediate module 74. The communication unit communicates with the evaluation electronics or with an external controller. By coupling the intermediate module with integrated communication unit, the main module can communicate with any available controller. Furthermore, a power supply unit can be integrated in the intermediate module. Hence, the main module can be retrofitted to a different power supply voltage or adapted to changed power supply voltages.

The communication subassembly may also contain multiple communication controllers, in order to communicate in different protocols at the same time. Hence, the option exists of incorporating the scanning unit in a ProfiNet environment and communicating with ProfiNet inside a machine, yet also communicating in parallel with the outside via, for example OPC UA, to an upper-level system or a cloud.

FIG. 5a shows the intermediate module 74 with adapted handle module 78 and without the main module 70.

FIG. 5b shows the intermediate module 74, where a connector 80 of a cable 82 of a first protocol such as ProfiNet has been connected to the electromechanical interface 76. The front-side electromechanical interface 72 comprises a U-shaped bracket 84 by means of which the main module 70 can be adapted to the intermediate module 74.

FIG. 5c shows the intermediate module 74 with another connector 86, for a cable 88 of another communication protocol.

FIG. 5d shows an embodiment in which the intermediate module 74 comprises a wireless radio connection 90 for connecting to a controller (not shown).

The intermediate module, the main module and the handle module 70 are designed for industrial use and consist entirely or partly of a robust material, such as a metal.

Preferably, the modules are formed as a single piece from a block of material, such as by milling. Alternatively, materials such as stainless steel, die casting, magnesium or carbon can be used. The materials may be machined or fabricated conventionally by lathe turning, milling, stamping, and/or bending, or by an additive manufacturing method (3D printing).

When a layout is being enlarged, redesigned, or disassembled, the image processing system (main module) can be easily adapted accordingly to new tasks.

In particular, a handheld scanner or handheld ID system can be easily redesigned by dismounting of the handle module 70 and attaching of the connector 80 or 86 of a handheld scanner to form a permanently mounted system.

The intermediate module can be powered either by cables 82, 88 or by means of an integrated storage battery. Communication protocols can be transmitted by cables or by a radio connection 90.

The data can be transmitted directly to a controller, a computer, or a gateway.

In the prior art, scanners in industrial image processing and industrial identification are always equipped with an internal communication interface. Therefore, the scanner basically has a dictated usage: whether it should/must be used as a permanently mounted scanner, the protocol with which it communicates, and so forth. There are scanners in which an internal circuit board can be exchanged. Yet these devices as well (handheld scanners) are designed to be used as handheld scanners. Only the communication protocol can be changed.

The scanner according to the invention has an adaptive design. The main module 70 contains the imaging unit, the evaluation unit, the optics unit, the illumination unit and the target marking. Thanks to the adaptive design, the option exists of using the scanner both as a handheld device and as a firmly installed device, wherein the main module can be connected to different power supply and communication subassemblies in order to make possible an adaptation to different communication protocols.

1. A code reader device (10), comprising a camera (12) having an image sensor (14) for generating images of a detection zone (18),
an auto focus unit (16) for projecting a focused image of the detection zone (18) onto the image sensor (14) and for determining a distance relative to a code (20) which has been read or an object which has been detected,
a decoding unit (46) for identifying the code (20) in the images and reading out its encoded information,
a calibrating unit (48) for calibrating the code reader and
a verification unit (50) for judging the code quality according to predefined criteria,
characterized in that the auto focus unit (16) is adapted to bringing codes (20) of different sizes and different distances relative to the image sensor (14) into automatic focus and providing a distance value relative to the code which was read or the object which was detected,
in that the calibrating unit (48) is adapted to providing norm-specific and distance-specific calibration parameters on the basis of said distance value and
in that the code reader device (10) comprises an illumination controller (52), which is adapted to adjusting a norm-specific and distance-specific illumination on the basis of the norm-specific and distance-specific calibration parameters by means of an illumination device (22, 30, 38).

2. The code reader device according to claim 1, characterized in that the norm-specific and distance-specific calibration parameters are stored in a memory of the calibrating unit (48).

3. The code reader device according to claim 1, characterized in that the illumination device comprises a coaxial illumination (22) for generating a diffuse bright field parallel to an optical axis (26).

4. The code reader device according to claim 1, characterized in that the illumination device comprises a preferably ring-shaped dome illumination (30) and a reflection device (34), such as a reflection dome, for generating a diffuse stray field not parallel to the optical axis (26).

5. The code reader device according to claim 1, characterized in that the illumination device comprises a dark field illumination (38) for generating a low angle illumination, the illumination angle is an acute angle a, preferably α=30°, and in that the illumination is oriented from one or more directions.

6. The code reader device according to claim 1, characterized in that the dome illumination (30) is situated in a margin of the reflector (34) encircling the end face.

7. The code reader device according to claim 1, characterized in that the dark field illumination (38) is situated in a margin of the reflector (34) encircling the end face.

8. The code reader device according to claim 1, characterized in that the dark field illumination (38) is designed as a separate illumination unit such as an illumination ring and it can be connected to the margin of the reflector (34) encircling the end face.

9. The code reader device according to claim 1, characterized in that the code reader device (10) is designed as a desktop apparatus, in that the code reader device (10) is integrated in a process metering apparatus, and/or in that the code reader device (10) is integrated in a handheld apparatus.

10. A method for online verification of a code (20), which is detected by an image sensor (14) of the code reader device (10) in an image, wherein the encoded information of the code (20) is read out and the code quality is judged according to predefined criteria, characterized in that codes (20) of different sizes and at different distances from the image sensor (14) are brought into focus automatically, in that a distance value of the code (20) or the object relative to the image sensor (14) is provided, in that norm-specific and distance-specific calibration parameters are provided on the basis of said distance value, and in that the read-in code (20) is verified automatically on the basis of said norm-specific and distance-specific calibration parameters and a predefined norm.

11. The method according to claim 10, characterized in that a norm-specific illumination (22, 30, 36) of the code (20) is automatically adjusted on the basis of the norm-specific and distance-specific calibration parameters.

12. The method according to claim 10, characterized in that the norm-specific and distance-specific calibration parameters comprise:
illumination settings such as brightness, illumination angle and/or light exposure time of the camera and/or the camera aperture.

13. The method according to claim 10, characterized in that the code (20) is illuminated with a coaxial illumination (22), dome illumination (30) and/or dark field illumination (38) according to the norm-specific and distance-specific calibration parameters.

14. The method according to claim 10, characterized in that the norm-specific and distance-specific calibration parameters are stored in a memory of a calibrating unit (48).

15. A code reading apparatus (68), comprising an illumination unit, an optics unit, an imaging unit, an evaluation unit and a communication unit, characterized in that the code reading apparatus (68) has a modular design, comprising a main module (78), in which the illumination unit, the optics unit, the imaging unit and the evaluation unit are integrated, and
an intermediate module (74), in which the communication unit is integrated,
wherein the intermediate module (74) comprises a first electromechanical interface (72) for connection to a handle module (70) and/or a data communication cable (82, 88) and a second electromechanical interface (76), to which the main module (78) is connectible.

16. The code reading apparatus according to claim 15, characterized in that the main module (78) comprises a first electromechanical interface for connecting to the intermediate module (74) and a second electromechanical interface for connecting of expansion modules such as diffuser/polar filter, fiberoptic cable for low angle illumination, dark field illumination and various optics.

17. The code reading apparatus according to claim 15, characterized in that the intermediate module (74) has an independent power supply such as a storage battery and/or in that the intermediate module (74) has a wireless radio connection.

18. The code reading apparatus according to claim 15, characterized in that the modules are made of a robust material such as aluminum, stainless steel, die casting, magnesium and/or carbon.

19. The code reading apparatus according to claim 15, characterized in that the modules are milled from a solid material and/or are fabricated conventionally by cutting machining, such as lathe turning, milling, or by noncutting machining, such as punching, bending, or additive manufacturing methods, such as 3D printing.
